(19) United States
(12) Patent Application Publication
(10) Pub. No.: US 2025/0298285 A1
(43) Pub. Date: Sep. 25, 2025

(54) OPTICAL DEVICE AND OPTICAL METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/054,131

(22) Filed: Feb. 14, 2025

Related U.S. Application Data
(60) Provisional application No. 63/567,077, filed on Mar. 19, 2024.

(30) Foreign Application Priority Data
Jan. 22, 2025 (TW) 114102678

(51) Int. Cl. G02F 1/29; G03B 17/17

(52) U.S. Cl. CPC G02F 1/29; G03B 17/17

(57) ABSTRACT

An optical device includes a first metamaterial lens layer, a second metamaterial lens layer, a first mirror layer, a second mirror layer, an imager element, and a substrate. The first mirror layer is attached to the first metamaterial lens layer. The second mirror layer is attached to the second metamaterial lens layer. The first mirror layer and the second mirror layer are adjacent to each other. The substrate is configured to carry the imager element. In response to an incident light transmitted through the second metamaterial lens layer, the first mirror layer can generate a first reflection light. In response to the first reflection light, the second mirror layer can generate a second reflection light. When the second reflection light is transmitted through the first metamaterial lens layer to the imager element, the imager element can generate an image signal.

### CROSS REFERENCE TO RELATED APPLICATIONS

This application claims the benefit of U.S. Provisional Application No. 63/567,077, filed on Mar. 19, 2024, and also claims priority of Taiwan Patent Application No. 114102678, filed on Jan. 22, 2025, the entirety of which are incorporated by reference herein.

### BACKGROUND OF THE INVENTION

### Field of the Invention

The invention relates in general to an optical device, and more particularly, it relates to an optical device for use in the field of photographic technology.

### Description of the Related Art

In the technology used to design cameras, there must often be a trade-off between refractive index and dispersion when dealing with conventional optical materials. However, an optical material with a low refractive index also tends to limit the performance and design flexibility of the optical device in question. Accordingly, there is a need to propose a novel solution for solving this problem of the prior art.

### BRIEF SUMMARY OF THE INVENTION

In an exemplary embodiment, the invention is directed to an optical device that includes a first metamaterial lens layer, a second metamaterial lens layer, a first mirror layer, a second mirror layer, an imager element, and a substrate. The first mirror layer is attached to the first metamaterial lens layer. The second mirror layer is attached to the second metamaterial lens layer. The first mirror layer and the second mirror layer are adjacent to each other. The substrate is configured to carry the imager element. In response to an incident light transmitted through the second metamaterial lens layer, the first mirror layer generates a first reflection light. In response to the first reflection light, the second mirror layer generates a second reflection light. When the second reflection light is transmitted through the first metamaterial lens layer to the imager element, the imager element generates an image signal.

In some embodiments, the operational frequency of the optical device is from 400 THz to 790 THz.

In some embodiments, the thickness of the first metamaterial lens layer is from 0.1 to 0.5 wavelength of the operational frequency.

In some embodiments, the thickness of the second metamaterial lens layer is from 0.1 to 0.5 wavelength of the operational frequency.

In some embodiments, the length of the first mirror layer is from 0.25 to 0.5 wavelength of the operational frequency.

In some embodiments, the length of the second mirror layer is from 0.25 to 0.5 wavelength of the operational frequency.

In some embodiments, the specific distance between the first mirror layer and the second mirror layer is from 0.125 to 1 wavelength of the operational frequency.

In some embodiments, the optical device further includes a controller for generating a first control voltage. The first control voltage is applied to the first metamaterial lens layer.

In some embodiments, the first refractive index of the first metamaterial lens layer is adjusted according to the first control voltage.

In some embodiments, the controller further generates a second control voltage, and the second control voltage is applied to the second metamaterial lens layer.

In some embodiments, the second refractive index of the second metamaterial lens layer is adjusted according to the second control voltage.

In another exemplary embodiment, the invention is directed to an optical method that includes the steps of: providing a first metamaterial lens layer, a second metamaterial lens layer, a first mirror layer and a second mirror layer, wherein the first mirror layer is attached to the first metamaterial lens layer, the second mirror layer is attached to the second metamaterial lens layer, and the first mirror layer and the second mirror layer are adjacent to each other; in response to an incident light transmitted through the second metamaterial lens layer, generating a first reflection light by the first mirror layer; in response to the first reflection light, generating a second reflection light by the second mirror layer; and when the second reflection light is transmitted through the first metamaterial lens layer to an imager element, generating an image signal by the imager element.

In some embodiments, the optical method further includes the step of applying a first control voltage to the first metamaterial lens layer.

In some embodiments, the optical method further includes the step of adjusting the first refractive index of the first metamaterial lens layer according to the first control voltage.

In some embodiments, the optical method further includes the step of applying a second control voltage to the second metamaterial lens layer.

In some embodiments, the optical method further includes the step of adjusting the second refractive index of the second metamaterial lens layer according to the second control voltage.

### BRIEF DESCRIPTION OF DRAWINGS

The invention can be more fully understood by reading the subsequent detailed description and examples with references made to the accompanying drawings, wherein:

FIG. 1 is a sectional view of an optical device according to an embodiment of the invention;

FIG. 2 is a sectional view of an optical device according to an embodiment of the invention; and

FIG. 3 is a flowchart of an optical method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

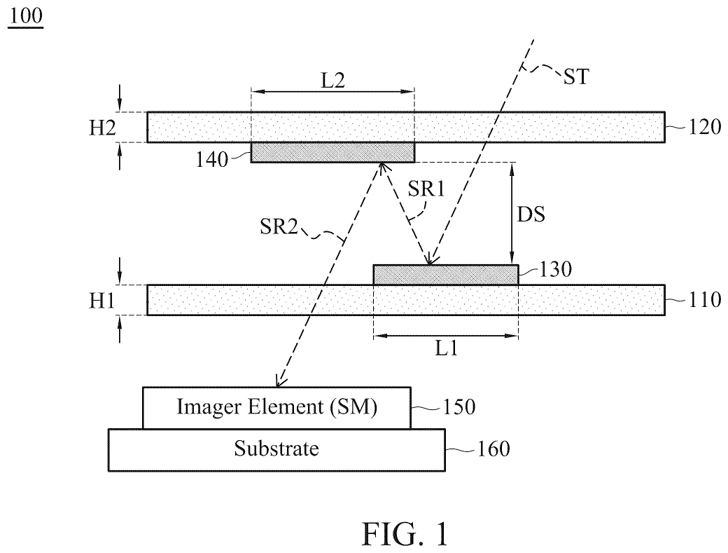

FIG. 1 is a sectional view of an optical device 100 according to an embodiment of the invention. The optical device 100 may be applied in a mobile device, such as a smart phone, a tablet computer, or a notebook computer. As shown in FIG. 1, the optical device 100 includes a first metamaterial lens layer 110, a second metamaterial lens layer 120, a first mirror layer 130, a second mirror layer 140, an imager element 150, and a substrate 160. It should be understood that the optical device 100 may further include other components, such as a processor, a battery element, and/or a housing, although they are not displayed in FIG. 1.

The shapes and types of the first metamaterial lens layer 110 and the second metamaterial lens layer 120 are not limited in the invention. The first metamaterial lens layer 110 has a periodical structure. Furthermore, the second metamaterial lens layer 120 has another periodical structure, which may be the same as or different from that of the first metamaterial lens layer 110.

Both of the first mirror layer 130 and the second mirror layer 140 are positioned between the first metamaterial lens layer 110 and the second metamaterial lens layer 120. Specifically, the first mirror layer 130 is attached to the first metamaterial lens layer 110, and the second mirror layer 140 is attached to the second metamaterial lens layer 120. The first mirror layer 130 and the second mirror layer 140 are adjacent to each other. It should be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0). In some embodiments, the optical device 100 further includes more mirror layers (not shown), which are also attached to the first metamaterial lens layer 110 and the second metamaterial lens layer 120.

For example, the imager element 150 may include an array composed of multiple CCDs (Charge-Coupled Devices) (not shown). Alternatively, the imager element 150 may be a CMOS (Complementary Metal-Oxide-Semiconductor) sensor, but it is not limited thereto. The substrate 160 is configured to carry the imager element 150.

In some embodiments, the operational principles of the optical device 100 will be described as follows. When the first mirror layer 130 receives an incident light ST transmitted through the second metamaterial lens layer 120, the first mirror layer 130 can generate and transmit a first reflection light SR1. For example, the aforementioned incident light ST may be from any light source, or may be any reflection light from any object. Next, when the second mirror layer 140 receives the first reflection light SR1, the second mirror layer 140 can generate and transmit a second reflection light SR2. Then, when the second reflection light SR2 is transmitted through the first metamaterial lens layer 110 to the imager element 150, the imager element 150 can generate an image signal SM according to the second reflection light SR2. In some embodiments, the optical device 100 provides a camera function. According to practical measurements, the first metamaterial lens layer 110 and the second metamaterial lens layer 120 have sufficient equivalent refractive indexes for fine-tuning the directions and phases of the incident light ST and the second reflection light SR2. The overall size of the optical device 100 using such a design can be significantly reduced due to the first metamaterial lens layer 110 and the second metamaterial lens layer 120's characteristics of thinness and lightness. According to practical measurements, the proposed optical device 100 of the invention can also stabilize the focal length and reduce the overall chromatic aberration.

In some embodiments, the operational frequency of the optical device 100 is from 400 THz to 790 THz. Furthermore, the frequency of each of the incident light ST, the first reflection light SR1, and the second reflection light SR2 also falls within the aforementioned range of the operational frequency of the optical device 100.

In some embodiments, the element sizes and element parameters of the optical device 100 will be described as follows. The thickness H1 of the first metamaterial lens layer 110 may be from 0.1 to 0.5 wavelength (λ/10˜λ/5) of the operational frequency of the optical device 100. The thickness H2 of the second metamaterial lens layer 120 may be from 0.1 to 0.5 wavelength (λ/10˜λ/5) of the operational frequency of the optical device 100. The length L1 of the first mirror layer 130 may be from 0.25 to 0.5 wavelength (λ/4˜λ/2) of the operational frequency of the optical device 100. The length L2 of the second mirror layer 140 may be from 0.25 to 0.5 wavelength (λ/4˜λ/2) of the operational frequency of the optical device 100. The specific distance DS between the first mirror layer 130 and the second mirror layer 140 may be from 0.125 to 1 wavelength (λ/8˜1λ) of the operational frequency of the optical device 100. Within the interval of the specific distance DS, a filling dielectric material may be filled, in addition to the air gap structure. The selection of the aforementioned filling dielectric material depends on the technology and application requirements. The aforementioned filling dielectric material may include SiO₂, Si₃N₄, a high-k material (such as HfO₂), or a low-k material (such as SiOF), etc. The above ranges of element sizes and element parameters are calculated and obtained according to many experimental results, and they help to improve the equivalent refractive index of the optical device 100 and also to minimize the overall size of the optical device 100.

The following embodiments will introduce different configurations and detail structural features of the optical device 100. It should be understood that these figures and descriptions are merely exemplary, rather than limitations of the invention.

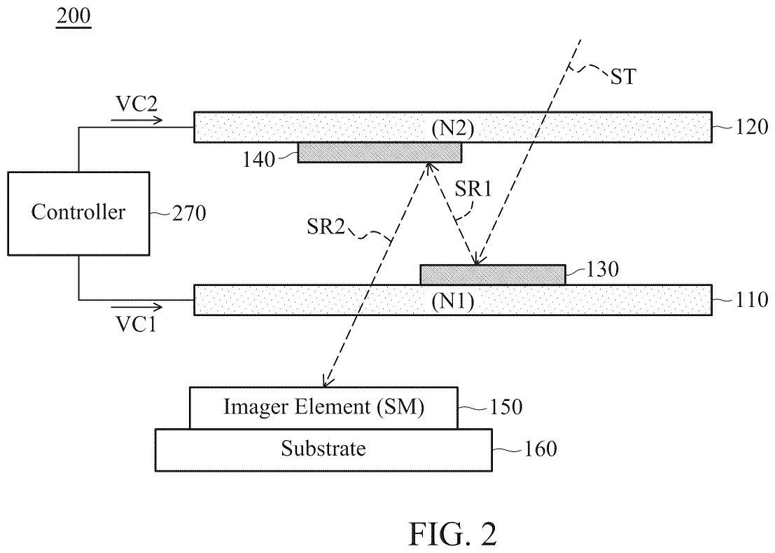

FIG. 2 is a sectional view of an optical device 200 according to an embodiment of the invention. FIG. 2 is similar to FIG. 1. In the embodiment of FIG. 2, the optical device 200 further includes a controller 270. The controller 270 can generate a first control voltage VC1 and a second control voltage VC2. The first control voltage VC1 is applied to the first metamaterial lens layer 110. The second control voltage VC2 is applied to the second metamaterial lens layer 120. For example, each of the first control voltage VC1 and the second control voltage VC2 may be a DC (Direct Current) voltage or an AC (Alternating Current) voltage. It should be noted that the first refractive index N1 of the first metamaterial lens layer 110 can be adjusted according to the first control voltage VC1, and the second refractive index N2 of the second metamaterial lens layer 120 can be adjusted according to the second control voltage VC2. Thus, the directions and phases of the incident light ST and the second reflection light SR2 can be further optimized based on different requirements. Other features of the optical device 200 of FIG. 2 are similar to those of the optical device 100 of FIG. 1. Accordingly, the two embodiments can achieve similar levels of performance.

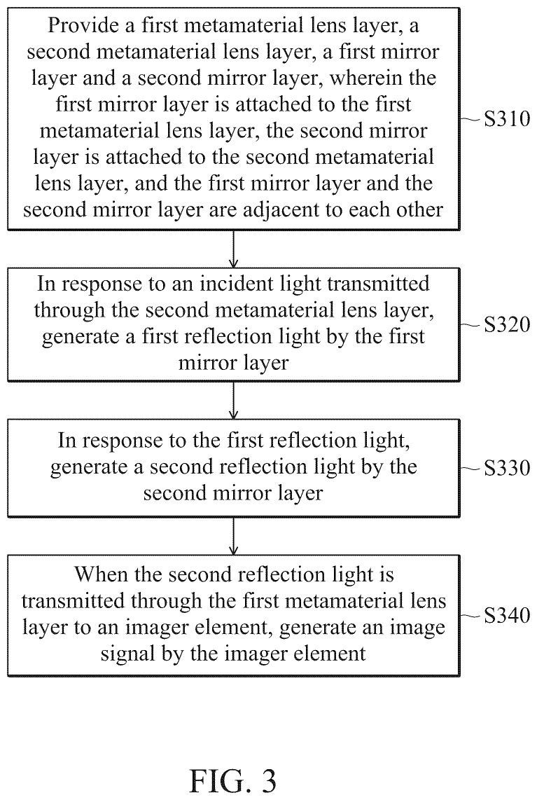

FIG. 3 is a flowchart of an optical method according to an embodiment of the invention. To begin, in step S310, a first metamaterial lens layer, a second metamaterial lens layer, a first mirror layer, and a second mirror layer are provided. The first mirror layer is attached to the first metamaterial lens layer. The second mirror layer is attached to the second metamaterial lens layer. The first mirror layer and the second mirror layer are adjacent to each other. In step S320, in response to an incident light transmitted through the second metamaterial lens layer, a first reflection light is generated by the first mirror layer. In step S330, in response to the first reflection light, a second reflection light is generated by the second mirror layer. Finally, in step S340, when the second reflection light is transmitted through the first metamaterial lens layer to an imager element, an image signal is generated by the imager element. It should be understood that these steps are not required to be performed in order, and every feature of the embodiments of FIG. 1 and FIG. 2 may be applied to the optical method of FIG. 3.

The invention proposes a novel optical device and a novel optical method. In comparison to the conventional design, the invention has at least the advantages of minimizing the overall size, increasing the equivalent refractive index, stabilizing the focal length, and reducing the overall chromatic aberration. Therefore, the invention is suitable for application in a variety of devices.

Note that the above element sizes and element parameters are not limitations of the invention. A designer can fine-tune these setting values according to different requirements. It should be understood that the optical device and the optical method of the invention are not limited to the configurations of FIGS. 1-3. The invention may include any one or more features of any one or more embodiments of FIGS. 1-3. In other words, not all of the features displayed in the figures should be implemented in the optical device and the optical method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An optical device, comprising:
a first metamaterial lens layer;
a first mirror layer, attached to the first metamaterial lens layer;
a second metamaterial lens layer;
a second mirror layer, attached to the second metamaterial lens layer, wherein the first mirror layer and the second mirror layer are adjacent to each other;
an imager element; and
a substrate, carrying the imager element;
wherein in response to an incident light transmitted through the second metamaterial lens layer, the first mirror layer generates a first reflection light;
wherein in response to the first reflection light, the second mirror layer generates a second reflection light;
wherein when the second reflection light is transmitted through the first metamaterial lens layer to the imager element, the imager element generates an image signal.

2. The optical device as claimed in claim 1, wherein an operational frequency of the optical device is from 400 THz to 790 THz.

3. The optical device as claimed in claim 2, wherein a thickness of the first metamaterial lens layer is from 0.1 to 0.5 wavelength of the operational frequency.

4. The optical device as claimed in claim 2, wherein a thickness of the second metamaterial lens layer is from 0.1 to 0.5 wavelength of the operational frequency.

5. The optical device as claimed in claim 2, wherein a length of the first mirror layer is from 0.25 to 0.5 wavelength of the operational frequency.

6. The optical device as claimed in claim 2, wherein a length of the second mirror layer is from 0.25 to 0.5 wavelength of the operational frequency.

7. The optical device as claimed in claim 2, wherein a specific distance between the first mirror layer and the second mirror layer is from 0.125 to 1 wavelength of the operational frequency.

8. The optical device as claimed in claim 1, further comprising:
a controller, generating a first control voltage, wherein the first control voltage is applied to the first metamaterial lens layer.

9. The optical device as claimed in claim 8, wherein a first refractive index of the first metamaterial lens layer is adjusted according to the first control voltage.

10. The optical device as claimed in claim 8, wherein the controller further generates a second control voltage, and the second control voltage is applied to the second metamaterial lens layer.

11. The optical device as claimed in claim 10, wherein a second refractive index of the second metamaterial lens layer is adjusted according to the second control voltage.

12. An optical method, comprising the steps of:
providing a first metamaterial lens layer, a second metamaterial lens layer, a first mirror layer and a second mirror layer, wherein the first mirror layer is attached to the first metamaterial lens layer, the second mirror layer is attached to the second metamaterial lens layer, and the first mirror layer and the second mirror layer are adjacent to each other;
in response to an incident light transmitted through the second metamaterial lens layer, generating a first reflection light by the first mirror layer;
in response to the first reflection light, generating a second reflection light by the second mirror layer; and
when the second reflection light is transmitted through the first metamaterial lens layer to an imager element, generating an image signal by the imager element.

13. The optical method as claimed in claim 12, wherein an operational frequency of the optical method is from 400 THz to 790 THz.

14. The optical method as claimed in claim 13, wherein a length of the first mirror layer is from 0.25 to 0.5 wavelength of the operational frequency.

15. The optical method as claimed in claim 13, wherein a length of the second mirror layer is from 0.25 to 0.5 wavelength of the operational frequency.

16. The optical method as claimed in claim 13, wherein a specific distance between the first mirror layer and the second mirror layer is from 0.125 to 1 wavelength of the operational frequency.

17. The optical method as claimed in claim 12, further comprising:
applying a first control voltage to the first metamaterial lens layer.

18. The optical method as claimed in claim 17, further comprising:
adjusting a first refractive index of the first metamaterial lens layer according to the first control voltage.

19. The optical method as claimed in claim 17, further comprising:
applying a second control voltage to the second metamaterial lens layer.

20. The optical method as claimed in claim 19, further comprising:
adjusting a second refractive index of the second metamaterial lens layer according to the second control voltage.
